(19) United States
(12) Patent Application Publication
(10) Pub. No.: US 2009/0037306 A1
(43) Pub. Date: Feb. 5, 2009

(54) System and Method for Managing Customer Interactions

(75) Inventor: Rosemary Hill, Jacksonville, FL (US)

Correspondence Address: BANNER & WITCOFF, LTD;ATTORNEYS FOR CLIENT NUMBER 007131, 10 SOUTH WACKER DR., SUITE 3000, CHICAGO, IL, 60606, US

(73) Assignee: BANK OF AMERICA CORPORATION, Charlotte, NC (US)

(21) Appl. No.: 11/831,192

(22) Filed: Jul. 31, 2007

(51) Int. Cl. G06Q 40/00; G06F 17/30; G06Q 10/00

(52) U.S. Cl. 705/35; 705/1

(57) ABSTRACT

Systems and methods for managing customer interactions allow an organization or individual to identify, prioritize, and manage customer interactions efficiently prior to a customer reaching a specialized customer service agent or station. A terminal may be used in a lobby of an office or business (e.g., by a lobby leader) to identify, queue, and process customers. For example, in a banking environment, a customer's needs and identification information may be collected and/or identified prior to the customer reaching a bank teller or other transaction station by a lobby leader. In one or more instances, a terminal used by a lobby leader may be configured to process one or more transactions so that the customer does not need to wait in a queue. A lobby leader terminal may also include a variety of other functions to facilitate customer management.

### BACKGROUND

Managing customer interactions efficiently is an ever present challenge in any business. In many instances, businesses must identify and satisfy customer needs through customer interactions. However, a business may often expend unnecessary resources in identifying and satisfying customer needs, if a business is able to identify these needs at all. Moreover, businesses often subject customers to repetitious and confusing processes, reducing both customer happiness and business efficiency. These repetitious and confusing processes often stem from a lack of understanding, prioritization, and management of customer interactions.

### SUMMARY

This summary is provided to introduce a selection of concepts in a simplified form that are further described below in the Detailed Description. The Summary is not intended to identify key features or essential features of the claimed subject matter, nor is it intended to be used to limit the scope of the claimed subject matter.

A system and method for managing customer interactions allows an organization or individual to understand, prioritize, and manage customer interactions in an efficient manner. A lobby leader terminal may be used in a lobby of a local office to identify, queue, and process customers. In conjunction with one or more back office systems, the lobby leader terminal may allow a lobby leader to resolve transactions, develop sales opportunities, and transfer customer information in the lobby. Initially, a customer may be identified with the lobby leader terminal via a banking card or a Radio-Frequency Identification (RFID) device. The customer identification information may be transmitted to a back office system to retrieve additional customer information such as bank account information, customer preferences, transaction history and the like. Based on the information received and the transaction or need identified by the customer, an appropriate queue may then be identified. For example, deposits and withdrawals may be performed by a bank teller while loans may require interaction with a loan officer. Thus, different queues may exist for different transactions. A customer may then be queued chronologically or by priority status and queues may be synchronized with external calendar software.

According to one or more aspects, some transactions may be performed and completed on the lobby leader terminal in the lobby. That is, the lobby leader terminal may have the appropriate software, firmware and/or hardware to perform certain transactions. Thus, rather than have a customer wait in line, a user of the lobby leader terminal may perform the requested transaction. However, other transactions may only be prepared on the lobby leader terminal. Preparation may include adding details to a transaction request and adding that information to the customer's entry in a queue.

According to one or more further aspects, the lobby leader terminal may enable a user to communicate electronically with others via electronic mail, instant message, or otherwise. For example, the lobby leader terminal may display a window in which a user may compose and view electronic mail and/or instant messages, and the lobby leader terminal may transmit and receive electronic mail and/or instant messages. This electronic communication may be used in order to notify employees of queue status or other information. For example, if a user of a lobby leader terminal assigns a customer to a particular bank teller's queue, the lobby leader terminal may transmit an instant message to that bank teller notifying the bank teller of the assignment.

### BRIEF DESCRIPTION OF THE DRAWINGS

The foregoing summary of the claimed subject matter, as well as the following detailed description of illustrative embodiments, is better understood when read in conjunction with the accompanying drawings, which are included by way of example, and not by way of limitation with regard to the claimed subject matter.

FIG. 1 illustrates a computing environment in which one or more aspects described herein may be implemented.

FIG. 2 illustrates a system in which one or more aspects described herein may be implemented.

FIG. 3 is a flowchart illustrating a method for identifying, queuing, and processing customers and their transactions.

FIG. 4 is a flowchart illustrating a method for receiving a request, searching database records, and transmitting a response.

FIG. 5 illustrates a user interface displaying banking information and functions according to one or more aspects described herein.

FIG. 6 illustrates a user interface showing an electronic mail function according to one or more aspects described herein.

FIG. 7 illustrates a user interface showing an instant messaging function according to one or more aspects described herein.

FIG. 8 illustrates a user interface showing an external work order function according to one or more aspects described herein.

FIG. 9 illustrates a user interface showing a metrics display function according to one or more aspects described herein.

FIG. 10 is a flowchart illustrating a method for identifying, queuing, and transferring customers in a lobby.

FIG. 11 is a flowchart illustrating a method for identifying customers and completing transactions in a lobby.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized and structural and functional modifications may be made without departing from the scope of the present claimed subject matter.

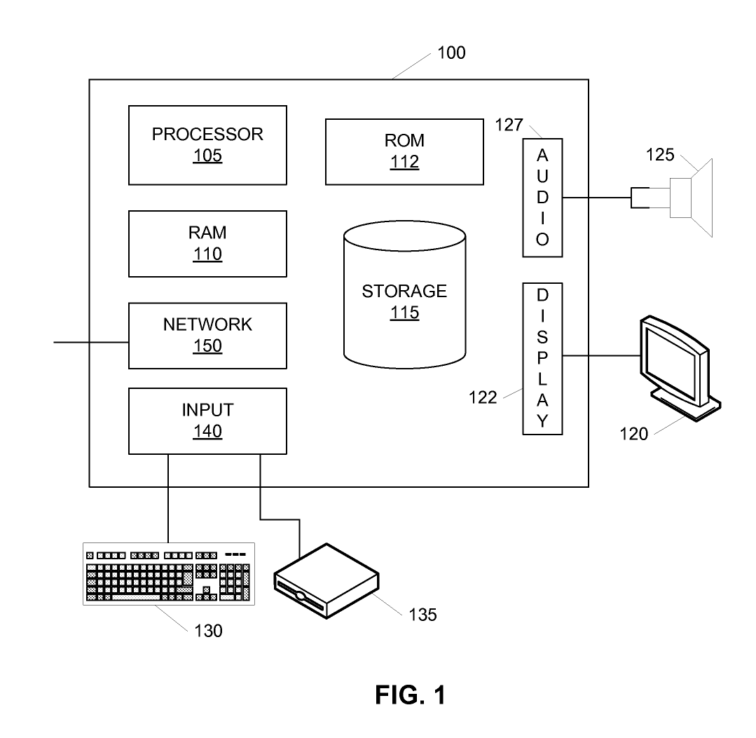

FIG. 1 illustrates a computing environment in which one or more aspects described herein may be implemented. A computing device such as computer 100 may house a variety of components for inputting, outputting, storing and processing data. For example, processor 105 may perform a variety of tasks including executing one or more applications, retrieving data from a storage device such as storage 115 and/or outputting data to a device such as display 120. Processor 105 may be connected to Random Access Memory (RAM) module 110 in which application data and/or instructions may be temporarily stored. RAM module 110 may be stored and accessed in any order, providing equal accessibility to the storage locations in RAM module 110. Computer 100 may further include Read Only Memory (ROM) 112 which allows data stored thereon to persist or survive after computer 100 has been turned off. ROM 112 may be used for a variety of purposes including for storage of computer 100's Basic Input/Output System (BIOS). ROM 112 may further store date and time information so that the information persists even through shut downs and reboots. In addition, storage 115 may provide long term storage for a variety of data including applications and data files. Storage 115 may include any of a variety of computer readable mediums such as disc drives, optical storage mediums, magnetic tape storage systems, flash memory and the like. In one example, processor 105 may retrieve an application from storage 115 and temporarily store the instructions associated with the application RAM module 110 while the application is executing.

Computer 100 may output data through a variety of components and devices. As mentioned above, one such output device may be display 120. Another output device may include an audio output device such as speaker 125. Each output device 120 and 125 may be associated with an output adapter such as display adapter 122 and audio adapter 127, which translates processor instructions into corresponding audio and video signals. In addition to output systems, computer 100 may receive and/or accept input from a variety of input devices such as keyboard 130, storage media drive 135 and/or microphone (not shown). As with output devices 120 and 125, each of the input devices 130 and 135 may be associated with an adapter 140 for converting the input into computer readable/recognizable data. In one example, voice input received through microphone (not shown) may be converted into a digital format and stored in a data file. In another example, credit card input may be received through a card reader (not shown) and converted into a digital format. In one or more instances, a device such as media drive 135 may act as both an input and output device allowing users to both write and read data to and from the storage media (e.g., DVD-R, CD-RW, etc.).

Computer 100 may further include one or more communication components for receiving and transmitting data over a network. Various types of networks include cellular networks, digital broadcast networks, Internet Protocol (IP) networks and the like. Computer 100 may include adapters suited to communicate through one or more of these networks. In particular, computer 100 may include network adapter 150 for communication with one or more other computer or computing devices over an IP network. In one example, adapter 150 may facilitate transmission of data such as electronic mail messages and/or financial data over a company or organization's network. In another example, adapter 150 may facilitate transmission or receipt of information from a world wide network such as the Internet. Adapter 150 may include one or more sets of instructions relating to one or more networking protocols. For example adapter 150 may include a first set of instructions for processing IP network packets as well as a second set of instructions associated with processing cellular network packets. In one or more arrangements, network adapter 150 may provide wireless network access for computer 100.

One of skill in the art will appreciate that computing devices such as computer 100 may include a variety of other components and is not limited to the devices and systems described in FIG. 1.

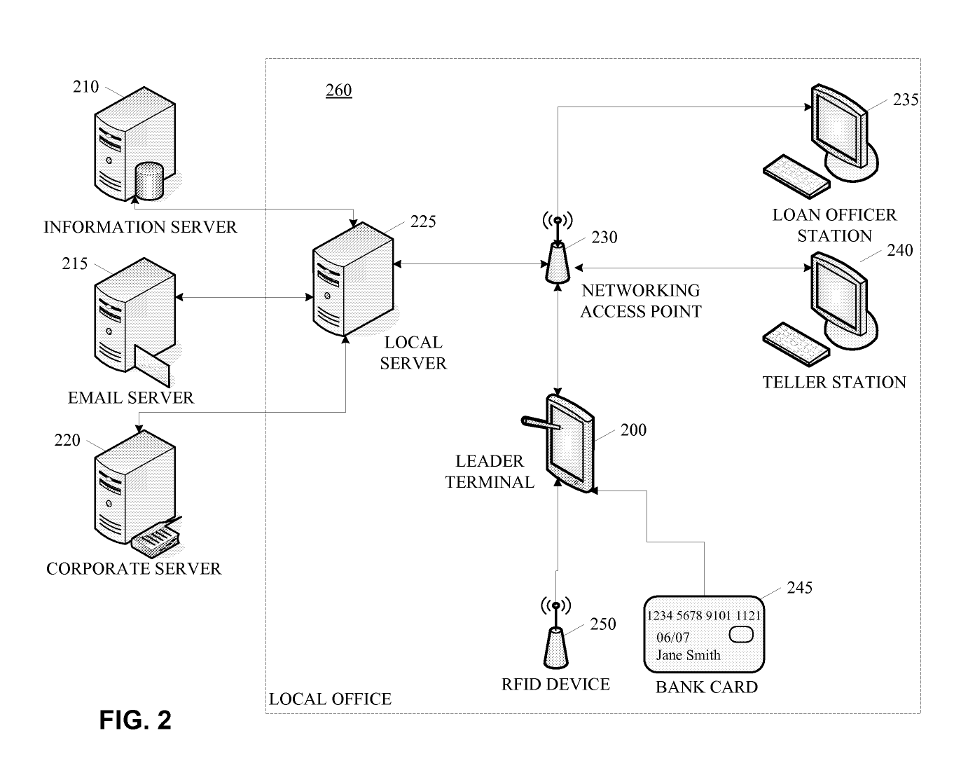

FIG. 2 illustrates a system environment that may incorporate one or more aspects described herein. The system may include a local office 260 in addition to remote servers, e.g. institutional information server 210, email server 215, and corporate server 220. Within local office 260, local server 225 may be connected to a networking access point 230. Institutional information server 210 may be configured to process requests for customer information and validate transactions. Email server 215 may be configured to process and exchange email messages between one or more recipients and senders. Corporate server 220 may be configured to host a corporate intranet or other private network, which may further provide marketing information, sales goals, software updates, and other features to employees. Network access point 230 may utilize a number of different wireless and wired network connection standards and protocols, including, but not limited to, Internet Protocol (IP), TCP/IP, Institute of Electrical and Electronics Engineers (IEEE) 802.11(b), 802.11(g), and 802.11(a). In addition, local server 225 may be connected to other servers outside of local office 260, via intranet, Internet, or other means. For example, local server 225 may be connected to institutional information server 210, email server 215, and corporate server 220. In one or more arrangements, any of servers 210, 215, 220 and 225 may be local or remote depending on the preferences of the business (e.g., a banking institution).

Further within local office 260, network access point 230 may be connected to a plurality of customer service terminals or other computing devices by wired or wireless connections. For example, network access point 230 may be connected to a loan officer station 235 and/or a teller station 240 in a banking institution environment. Loan officer station 235 and teller station 240 may be stationary transaction terminals or may be mobile transaction stations. Transaction terminals or stations generally refer to terminals or stations that are configured with software, firmware and/or hardware to perform one or more specialized functions or to handle particular types transactions.

In one or more configurations, network access point 230 may also be connected to a lobby leader terminal 200. Lobby leader terminal 200 may comprise a variety of computing systems and devices including PDAs, personal computers (PCs like computer 100 of FIG. 1), tablet computers, laptop computers, mobile phone devices and the like. A lobby leader terminal, as used herein, generally refers to a terminal used in a central location of a business office (e.g., a lobby or a location where customers initially enter or loiter) to assist a customer prior to the customer reaching a more specialized customer service station (e.g., loan officer station 235 or teller station 240). Lobby leader terminal 200 may be a stationary terminal or may be a mobile terminal. Lobby leader terminal 200 may connect to network access point 230 or other devices (not shown) via a number of different wired and wireless connections, including, but not limited to, IEEE 802.11(b), 802.11(g), 802.11(a), Bluetooth®, or local area network (LAN) connections. Additionally, lobby leader terminal 200 may be configured to receive data from a customer identification card 245 or a Radio-Frequency Identification (RFID) device 250. For example, lobby leader terminal 200 may include a radio frequency (RF) receiver or a magnetic strip reader. A customer identification card 245 may be a driver's license, credit card, debit card, or other type of banking card.

In one or more configurations, lobby leader terminal 200 may be a tablet computer equipped with or connected to a portable card reader. Lobby leader terminal 200 may be connected to a portable card reader via a wired or wireless connection. In one or more further configurations, lobby leader terminal 200 may be a stationary terminal configured to receive data from a stationary or portable card reader via a wired or wireless connection. Additionally, according to one or more aspects, lobby leader terminal 200 may be equipped with a privacy filter to reduce the viewing angle of the display, thereby maintaining the privacy of information displayed on the lobby leader terminal 200. Use of a privacy filter may be particularly relevant in the banking industry where customer information may be sensitive.

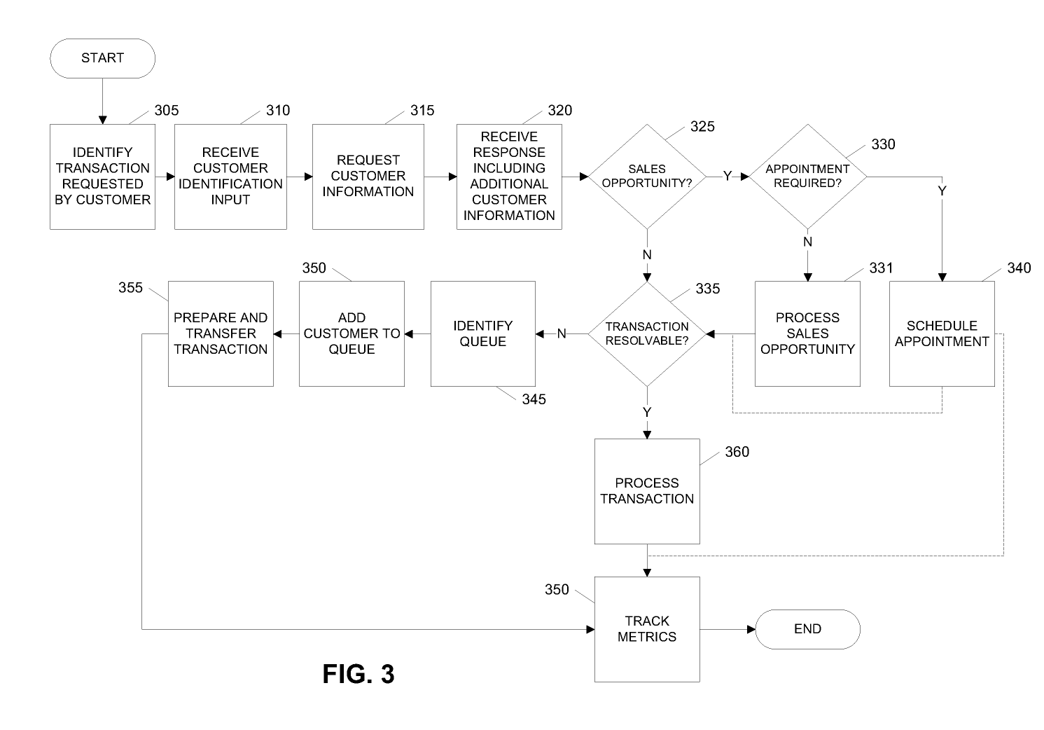

According to one or more aspects, a system for managing customer interactions such as lobby leader terminal 200 of FIG. 2 may be configured to identify, queue, and process customers and/or their transactions. FIG. 3 is a flowchart illustrating a method for identifying, queuing, and processing customers. In step 305, the system may identify a transaction requested by a customer. For example, the transaction may be identified as a deposit, withdrawal, transfer, loan, etc. The system may identify the transaction based on, for example, information submitted by the customer. In step 310, the system may receive customer identification information for identifying the customer requesting the identified transaction. Customer identification information may be received from an identification card (e.g., a banking card), an RFID device, manual entry, or using other methods. In one example, a user may facilitate the entry of customer identification information by swiping a customer's credit card in a card reader connected to the system or by manually entering a customer's name and account number. As another example, an RFID receiver connected to the system may detect a customer's RFID device and accordingly receive customer identification information stored in the RFID device into the system.

In step 315, the system may request additional customer information from another system such as a back office server, based on the received customer identification information. The system may request customer identification information from a local server 225 within the local office 260 (FIG. 2) or a remote server not within the local office, e.g. institutional information server 210 or corporate server 220 of FIG. 2. In step 320, the system may receive a response to the request for additional customer information. The response may include information such as an indication as to whether the customer has a bank account, account type, account balance, account history, and other information. In one or more arrangements, the additional customer information may indicate and include information regarding a sales opportunity.

In step 325, the system may determine whether a sales opportunity was indicated or otherwise included in the additional customer information. If a sales opportunity was indicated, the system may then determine, in step 330, whether an appointment is required to develop or process the sales opportunity. If an appointment is required, the system may, in step 340, schedule an appointment to develop the sales opportunity. If an appointment is not required, the system may, in step 331, process the sales opportunity. For example, if a credit card sales opportunity is indicated and a customer's name, address, and social security number are required to process the credit card sales opportunity, the system may process the credit card sales opportunity by validating the customer's name, address, and social security number and requesting a credit card be issued upon satisfaction of a credit check or approval.

In step 335, the system may determine, whether the identified transaction is resolvable on the system. For example, if the transaction requested by the customer is a transfer of funds, the transaction may be resolvable on the system if the system is configured with such functionality. If the transaction is resolvable by the system, then the system, in step 360, may process the transaction. In one or more configurations, even if the system identifies a sales opportunity, the system may proceed to process a transaction originally requested by the customer after scheduling an appointment or processing the sales opportunity. Additionally, in step 361, the system may track one or more metrics associated with customer and transaction management. For example, the system may capture and record data relating to efficiency and performance, such as the number of customers identified by the system, the number of customers currently waiting, and the number of customers queued by the system.

If the transaction is not resolvable by the system, then the system, in step 345, may identify a queue from a plurality of queues in which to place the customer. A queue may be identified by the category or type of transaction with which the customer needs help. Thus, a customer requesting a loan may be queued with a manager or loan officer while a deposit request customer may be queued in a bank teller line. In one or more arrangements, the queue may be ordered by chronological arrival of customers or by customer priority status. For example, customer priority status may be based on account type, such that a “Premier” customer may have higher priority status in the queue than an “Advantage” customer. In addition, the system may synchronize with a calendar system or function in order to update the plurality of queues and each queue therein. For example, the system may synchronize with an electronic calendar in order to determine which employees are available to work with customers at particular times.

In step 350, the system may add the customer to the identified queue. According to one or more arrangements, a user of the system may manually add the customer to an identified queue by a drag-and-drop operation. For example, a user of the lobby leader terminal may drag and drop, using an input device such as a mouse or touch-sensitive interface, the display representation of the customer onto the display representation of the identified queue in order to add the customer to the identified queue. In step 355, the system may prepare the customer's transaction. For example, if the transaction requested by the customer is a withdrawal, the system may confirm that the customer has sufficient funds in his or her account to make the withdrawal. In addition, the system may prepare the customer's transaction by transferring the customer identification information and additional customer information accessed on the lobby leader terminal 200 to customer service station or agent, e.g. the teller station 240 or the loan officer station 260, so as to reduce repetition and increase efficiency.

Additionally or alternatively, the system may perform additional steps to facilitate the composing, transmitting, and receiving of electronic mail. For example, the system may display a button and/or a link allowing a user to compose or view electronic mail. Upon the user clicking on the button and/or the link, the system may display a window allowing a user to compose an electronic mail message. The system may then transmit the message over a network when commanded by the user. The system may also receive electronic mail and display a window in which the user may view received electronic mail messages. Additionally or alternatively, the system may perform additional steps to facilitate the composition, transmission, and reception of instant messages. For example, the system may display a button and/or a link allowing a user to compose or view electronic mail. Upon the user clicking on the button and/or the link, the system may display a window allowing a user to compose an instant message to a customer service agent at a teller station or loan station. The system may then transmit the message over a network. The system may also receive an instant message and display a window in which the user may view received instant messages. In displaying an instant message, the system may additionally include information to identify the source of the instant message, e.g., the sender's name, username, IP address, or other identification information.

Further, the system may be configured to encrypt data upon transmitting data and decrypt data upon receiving data. Encrypting and decrypting data may improve the security and integrity of the system and the information contained therein. For example, before requesting customer identification information in step 315, lobby leader terminal 200 may encrypt the customer identification input. Continuing this example, upon receiving a response in step 320, the lobby leader terminal 200 may decrypt the response. This encryption/decryption process can be applied to any step involving the transmitting or receiving of data.

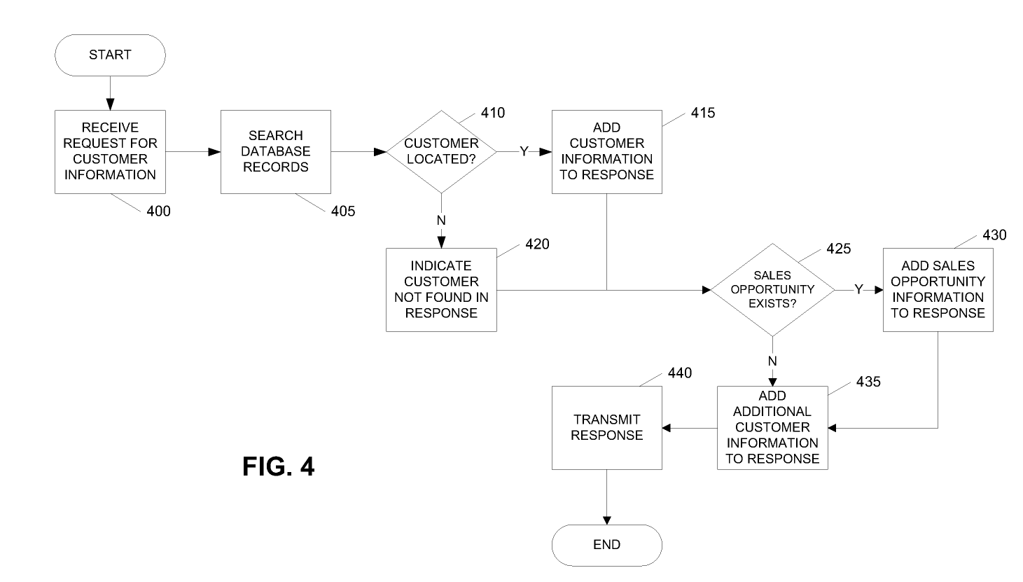

FIG. 4 is a flowchart illustrating a method for receiving a request from a lobby leader system, searching database records for customer information, and transmitting a response. In step 400, the system may receive a request for customer information from another system or device such as lobby leader terminal 200 (FIG. 2). The request may include customer identification information, such as a credit card number or social security number, to facilitate customer identification. In step 405, the system may search database records, based on the received request, to locate customer information. In step 410, the system may determine whether customer exists or was successfully located in the database.

If the customer was located in the database, the system may, in step 415, add the customer identification information to the response. If the customer was not located, however, the system may, in step 420, add a customer not found notice or another indicator to the response. For example, if a customer is a new customer to a bank, the customer would not yet have a bank account. Thus, the system may return with a corresponding message to indicate that this is a new customer to the user using the lobby leader terminal or other system.

In step 425, the system may determine whether a sales opportunity exists for the customer. For example, based on an analysis of customer identification information or other information in the database, the system may determine that a credit card, type of bank account, or mortgage sales opportunity exists. In one or more configurations, a sales opportunity or information related thereto may be entered into a database or associated with a customer account through manual entry into the database records, e.g., by a sales representative or the like.

If the system determines that a sales opportunity exists, the system may, in step 430, add sales opportunity information to the response. For example, if the system determines that a mortgage sales opportunity exists, the system may indicate in the added sales opportunity information particular terms of the mortgage or other specific information to develop the sales opportunity. As another example, if the system determines that a credit card opportunity exists, the system may indicate in the added sales opportunity information a particular type of card or other specific information to develop the sales opportunity. If the system determines that a sales opportunity does not exist, the system might not add sales opportunity information to the response.

In step 435, the system may add additional customer information to the response. For example, the system may add an invitation for the customer to take a survey or attend an event. In step 440, the system may transmit the response to the requesting terminal or device.

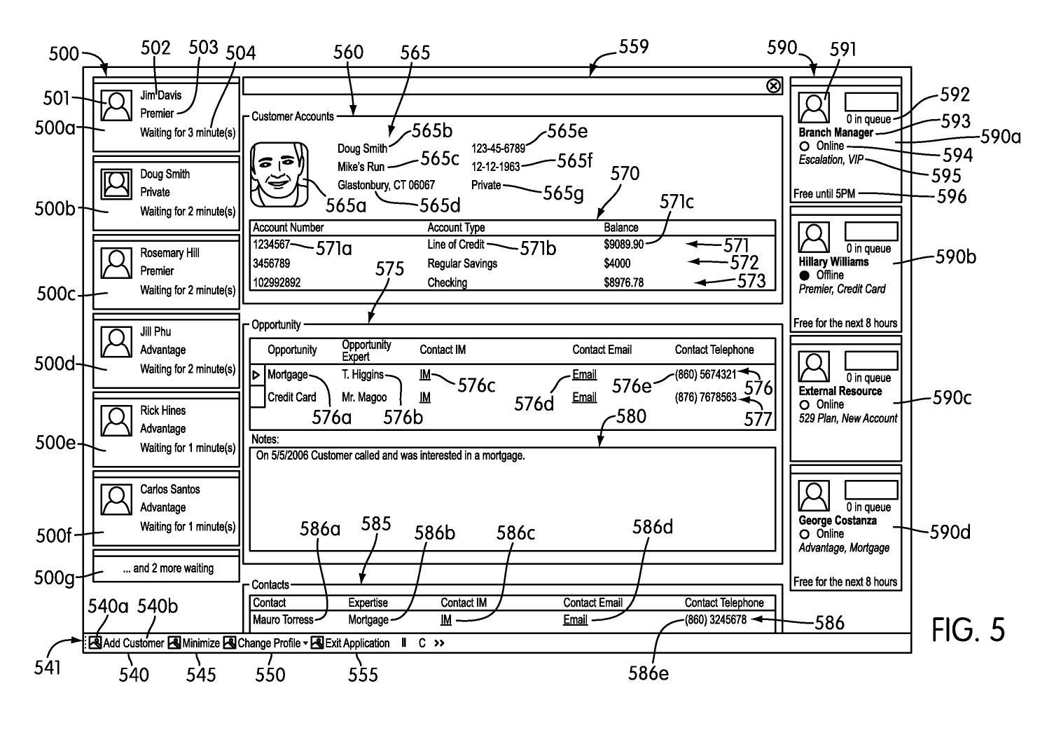

FIG. 5 illustrates a user interface displaying banking information and functions according to one or more aspects described herein. The user interface may include a plurality of customers 500 in a portion of the display and a plurality of queues 590 in another portion of the display. The location of features displayed on the user interface, i.e. whether a feature is displayed on the right side, left side, top, or bottom of the display, may vary between configurations and may be altered depending on user preferences. Within the plurality of customers 500, the system may display certain overview information about each customer. For example, with respect to customer 500a, the system may display the customer's picture or icon representation 501, the customer's name 502, the customer's priority status 503, and the length of time for which the customer has been waiting 504. The system may also indicate if more customers than those displayed in the plurality of customers 500 are waiting. For example, the system may display a quantity of additional customers 500g.

If a customer in the plurality of customers 500 is selected, the system may display an extended profile 559 of the selected customer. For example, the extended profile 559 displayed by the system in FIG. 5 corresponds to selected customer 500b. In displaying the extended profile 559, the system may display a “Customer Accounts” frame 560, an “Opportunity” frame 575, and a “Contacts” frame 585. Within the “Customer Accounts” frame 560, the system may display customer identification information 565 and customer account information 570. Additionally, within the “Opportunity” frame 575, the system may display sales opportunity information for various opportunities 576 and 577, and a “Notes” area 580.

In displaying customer identification information 565, the system may display the customer's picture or icon representation 565a (which may be distinct from the customer's picture or icon representation as displayed in the plurality of queues 500); the customer's name 565b; the customer's street address 565c; the customer's city, state, and ZIP code 565d; the customer's social security number 565e; the customer's date of birth 565f, and the customer's priority status 565g. In displaying customer account information 570, the system may display accounts 571, 572 and 573. Additionally, in displaying account 571, the system may display account number 571a, account type 571b, and account balance 571c.

In displaying sales opportunity information within the “Opportunity” frame 575, the system may display individual opportunities, e.g. opportunity 576 and opportunity 577. In displaying opportunity 576, the system may further display the type of opportunity 576a, the name of an expert associated with the opportunity 576b, a link to contact the expert via instant message 576c, a link to contact the expert via email 576d, and a number to contact the expert via telephone 576e. In addition, the system may display a “Notes” area 580 in which a user may enter notes to be stored in the database records.

In displaying a “Contacts” frame 585, the system may display individual contacts, e.g. contact 586. For example, in displaying contact 586, the system may display the contact's name 586a, the contact's expertise 586b, a link to communicate with the contact via instant message 586c, a link to communicate with the contact via email 586d, and a number to communicate with the contact via telephone 586e.

As discussed above, the system may, in one or more configurations, display a plurality of queues 590 on the right side of the display. Within the plurality of queues 590, the system may display individual queues, e.g. queue 590a, queue 590b, queue 590c, and queue 590d. In one or more configurations, a queue may correspond to a specific resource in the local office 260. For example, in displaying queue 590a, the system may display information about the specific resource to which the queue corresponds. Continuing this example, in displaying queue 590a, the system may display the specific resource's picture or icon representation 591, the specific resource's queue length 592, the specific resource's name or title 593, the specific resource's status 594, the specific resource's skills 595, and the specific resource's availability 596.

In one or more configurations, the customer may be added to the identified queue by a drag-and-drop operation. For example, a user of the lobby leader terminal may drag and drop, using an input device such as a mouse or touch-sensitive interface, a display representation of the customer, e.g. customer 500b, onto a display representation of the identified queue, e.g. queue 590d, in order to add the customer to the identified queue.

In one or more configurations, the system may display a menu bar 541 at the bottom of the display. In displaying the menu bar 541, the system may further display buttons corresponding to various functions. For example, the system may display an “Add Customer” button 540, a “Minimize” button 545, a “Change Profile” button 550, and an “Exit Application” button 555. Additionally, in displaying a button, the system may display a picture or icon representation and a text label corresponding to the operation of the button. For example, in displaying “Add Customer” button 540, the system may display a picture or icon representation 540a and a text label 540b corresponding to the “Add Customer” operation. In one or more configurations, these buttons may be submenus or other interactive tools. For example, the “Change Profile” button 550 may expand to reveal another sublevel of menu selections. One skilled in the art will understand that these submenus may further comprise submenus.

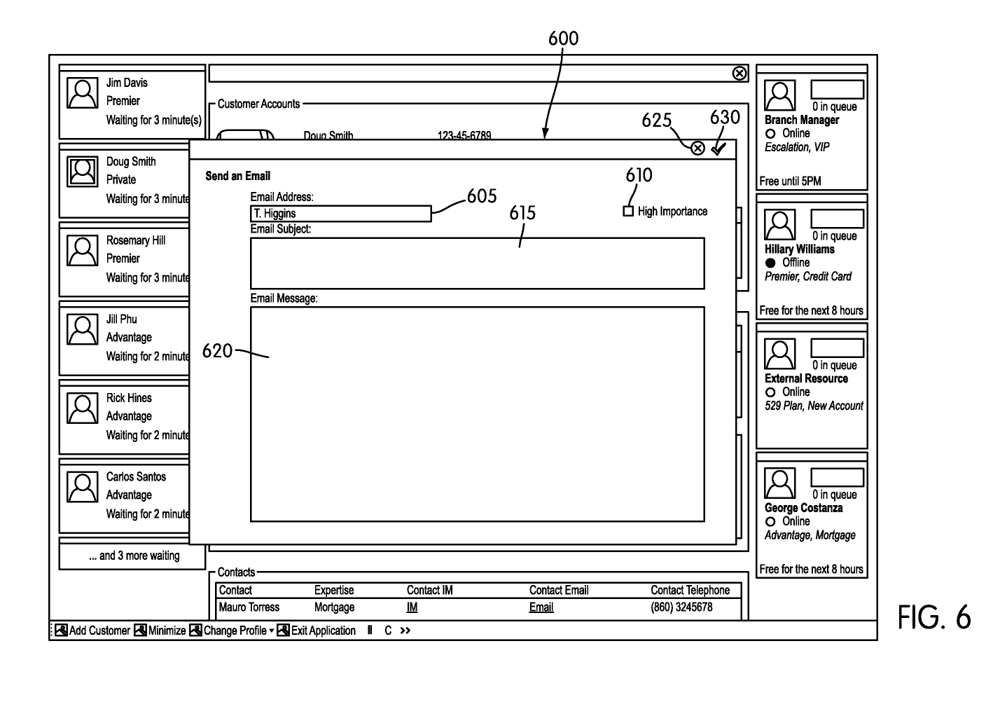

FIG. 6 illustrates a user interface showing an electronic mail function, e.g., window 600, according to one or more aspects described herein. The system may display electronic mail window 600 automatically or in response to a command by a user. For example, the system may display electronic mail window 600 whenever a new electronic mail message is received; the system may also display electronic mail window 600 when a user clicks on a button (e.g., clicks on a person to which he or she wishes to send an email) and/or link. The electronic mail window 600 may appear over other areas of the display and may comprise transparency visual effects. In displaying electronic mail window 600, the system may additionally display fields in which a user may enter information. For example, the system may display a field 605 in which a recipient's email address may be entered. The system may display a field 615 in which a message subject may be entered and a field 620 in which the message itself may be entered. Additionally, the system may display a field 610 allowing a priority level to be assigned to the message.

In displaying the electronic mail window 600, the system may further display buttons with which a user may interact. For example, the system may display a cancel button 625 and a send button 630, so that the user may choose whether to cancel or send the electronic mail message. Additionally, the system may also display an electronic mail window (not shown) in which the system may display electronic mail messages that are received. In displaying a received electronic mail message, the system may additionally include information to identify the source of the electronic message, e.g., the sender's name, username, IP address, or other identification information.

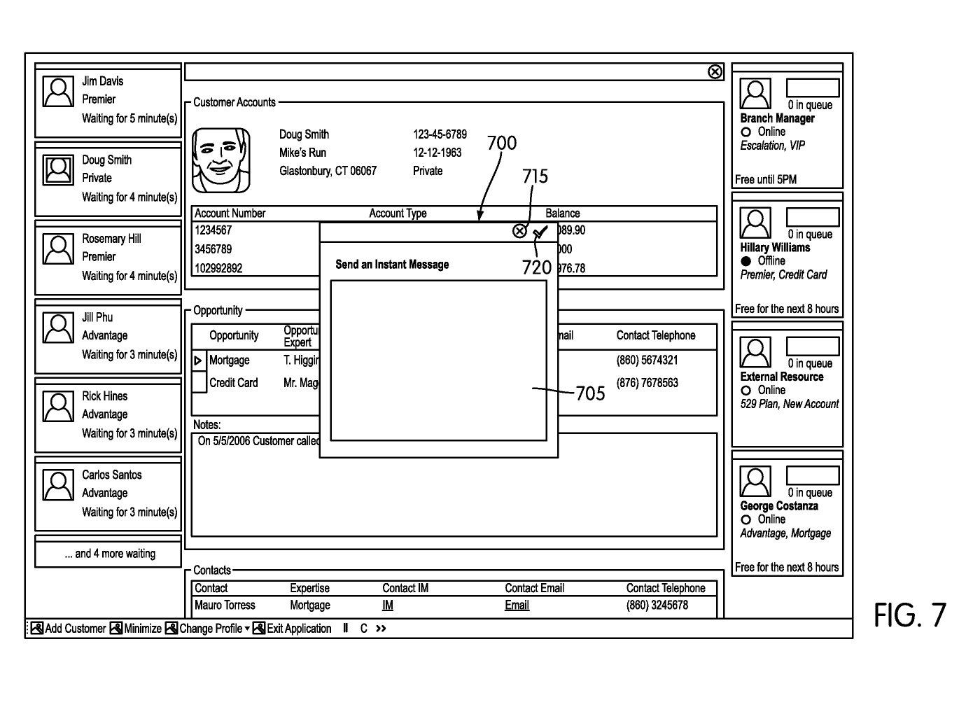

FIG. 7 illustrates a user interface showing an instant messaging function (e.g., instant message window 700) according to one or more aspects described herein. The system may display instant message window 700 automatically or upon command by a user. For example, the system may display instant message window 700 whenever a new instant message is received; the system may also display instant message window 700 when a user selects a user with which he or she wishes to communicate. In displaying instant message window 700, the system may also display a field 705 in which a message may be entered. Additionally, the system may display buttons with which a user may interact. For example, the system may display a cancel button 715 and a send button 720, so that the user may choose whether to cancel or send the instant message. Additionally, the system may also display an instant message window (not shown) in which the system may display instant messages that are received. In displaying a received instant message, the system may additionally include information to identify the source of the instant message, e.g., the sender's name, username, IP address, or other identification information.

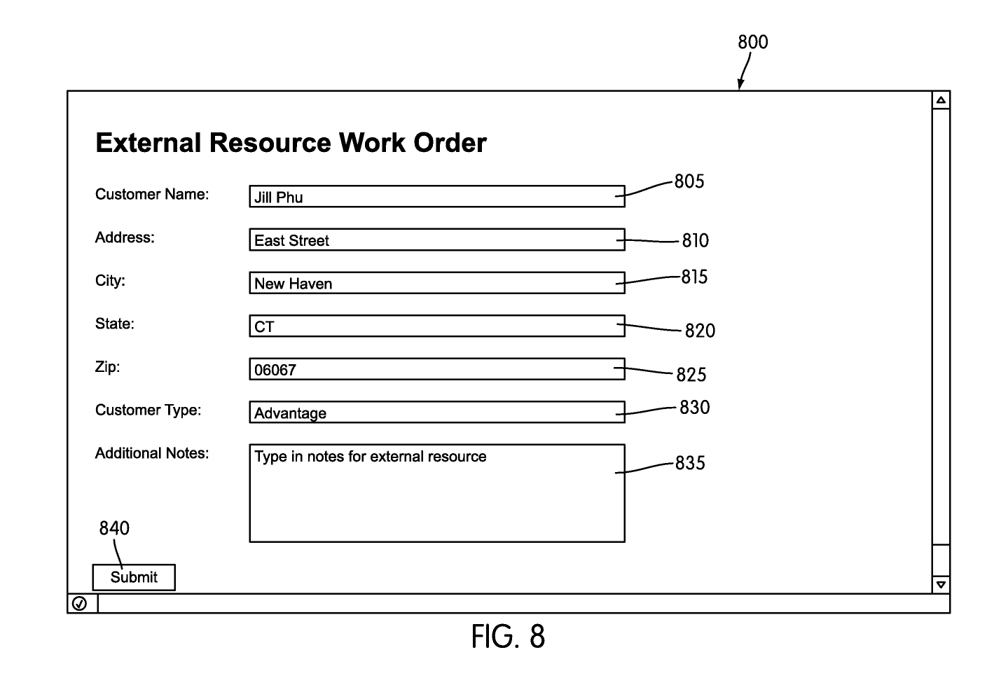

FIG. 8 illustrates a user interface showing an external work order function according to one or more aspects described herein. External work order 800 may allow a business to refer a customer to another resource not available at a local office. For example, if a customer requests insurance services not available at a local office, external work order 800 may allow a lobby leader to refer the customer to another office in which insurance services are available. External work order 800 may include fields in which a user may enter information such as display name field 805 in which a customer's name may be entered, address field 810 in which a customer's address may be entered, city field 815 in which a customer's city may be entered, state field 820 in which a customer's state may be entered, zipcode field 825 in which a customer's ZIP code may be entered, customer type field 830 in which a customer's type may be entered, and notes field 835 in which additional notes may be entered. Additionally, the system may display a button 840 by which a user may choose to submit the entered data to a server. In one or more configurations, external work order 800 may be automatically populated by the system based on known and/or received customer identification information. Additionally, the external work order 800 may be populated by a drag-and-drop operation. For example, a user of the lobby leader terminal may drag and drop, using an input device such as a mouse or touch-sensitive interface, the display representation of a customer onto the display representation of an external work order in order to populate the external work order.

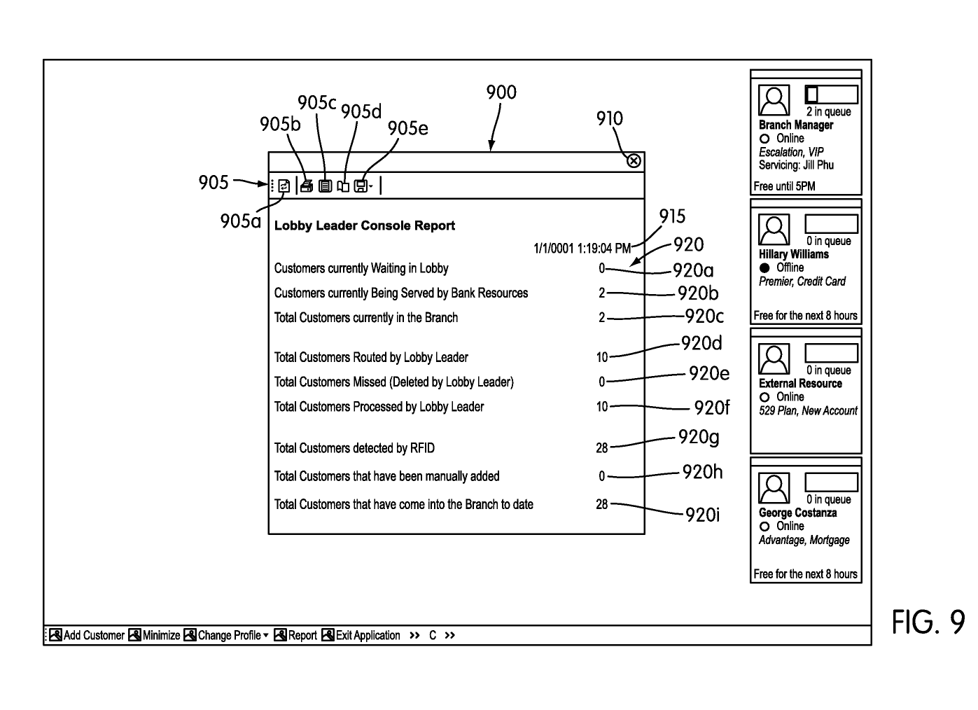

FIG. 9 illustrates a user interface showing a metrics display function according to one or more aspects described herein. In one or more configurations, the system may display a metrics report window 900. In displaying a metrics report window 900, the system may display a menu bar 905, which may include a plurality of buttons 905a, 905b, 905c, 905d, and 905e. These buttons may perform a variety of functions. For example, button 905a may refresh the report; button 905b may print the report; button 905c may show a print preview; button 905d may change the view; and button 905e may save the report. In one or more configurations, these buttons may be submenus. For example, the save button 905e may expand to reveal another sublevel of menu selections. One skilled in the art will understand that these submenus may further comprise submenus. Additionally, in displaying a metrics report window 900, the system may also display a close button 910 by which a user may close the metrics report window 900.

In addition, in displaying a metrics report window 900, the system may further display a timestamp 915 and a plurality of metrics 920. For example, the system may display the number of customers currently waiting in a lobby 920a; the number of customers currently being served by bank resources 920b; the total number of customers currently in a branch 920c; the total number of customers routed by a lobby leader 920d; the total number of customers missed by a lobby leader 920e; the total number of customers processed by a lobby leader 920f, the total number of customers detected by RFID 920g; the total number of customers that have been manually added 920h; and the total number of customers that have come into the branch to date 920i.

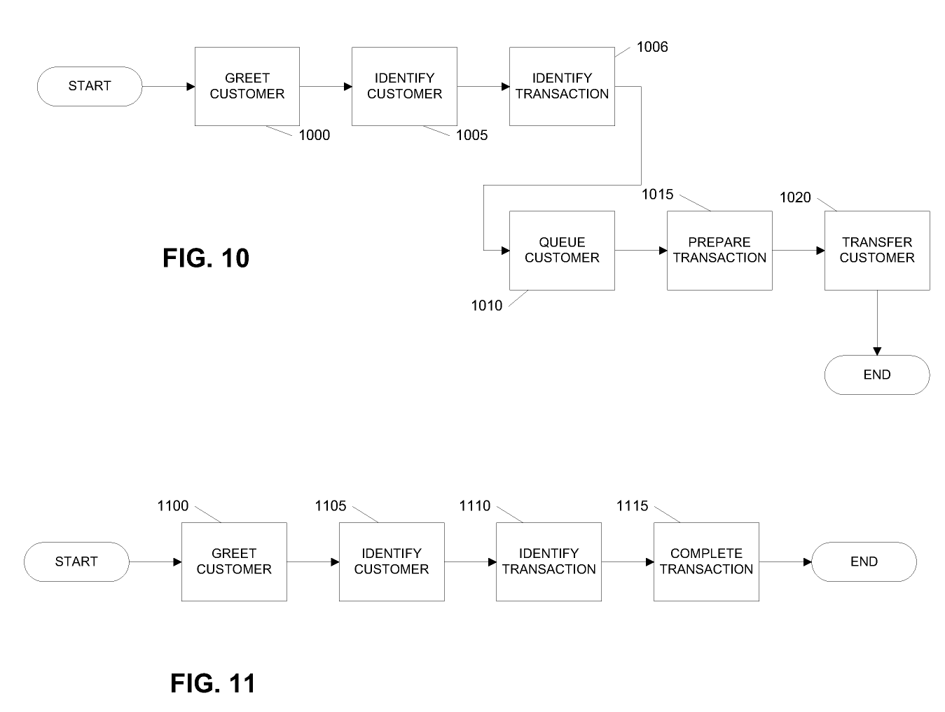

In one or more arrangements, a method for managing customer interactions may include identifying, queuing, and transferring customers in a lobby. FIG. 10 is a flowchart illustrating a method for identifying, queuing, and transferring customers in a lobby. In step 1000, a lobby leader may greet a customer in a lobby or a location where the customer initially enters or loiters prior to interacting with a specialized customer service agent such as a bank teller or loan officer. In step 1005, the lobby leader may identify the customer. For example, the lobby leader may use a lobby leader terminal (e.g., terminal 200 of FIG. 2) to receive customer identification information from a banking card 245 (FIG. 2) or an RFID device 250 (FIG. 2), and may use a lobby leader terminal to request and receive customer identification information and additional customer information in the lobby. The lobby leader may use a mobile implementation of a lobby leader terminal or a stationary implementation of a lobby leader terminal, depending on preferences and/or needs. In step 1006, the lobby leader may identify a transaction requested by a customer. For example, the transaction may be identified as a deposit, withdrawal, transfer, loan, etc. The lobby leader may identify the transaction based on, for example, information gathered from the customer. In step 1010, the lobby leader may queue the customer in one or more queues based on the customer's identity and/or a requested transaction. For example, having identified the customer, the lobby leader may use a lobby leader terminal 200 to identify a queue from a plurality of queues and add the customer to the identified queue in the lobby. Alternatively or additionally, the lobby leader may manually identify an appropriate queue in which to place the customer. In step 1015, the lobby leader may prepare the customer's transaction in the lobby. For example, the lobby leader may use a lobby leader terminal to prepare the customer's transaction in the lobby by obtaining necessary information and formatting the data in a predefined manner. In step 1020, the lobby leader may transfer or assign the customer to an appropriate resource from the lobby. For example, the lobby leader may use a lobby leader terminal to transfer the customer's customer identification information and additional customer information to a transaction terminal or station, e.g. teller station 240 or a loan officer station 260 of FIG. 2, where an agent may fulfill the customer's needs.

In one or more arrangements, a method for managing customer interactions may include identifying customers and completing transactions in a lobby prior to the customer reaching a predefined transaction station or terminal. FIG. 11 is a flowchart illustrating a method for identifying customers and completing transactions in a lobby environment. In step 1100, for example, a lobby leader may greet a customer in a lobby or other entry or waiting area. In step 1105, the lobby leader may identify the customer. For example, the lobby leader may use a lobby leader terminal (e.g., terminal 200 of FIG. 2) to receive customer identification input from a banking card 245 or an RFID device 250, and may use the lobby leader terminal to request and receive additional customer information in the lobby. In step 1106, the lobby leader may identify a transaction requested by a customer. For example, the transaction may be identified as a deposit, withdrawal, transfer, loan, etc. The lobby leader may identify the transaction based on, for example, information gathered from the customer. In step 1110, the lobby leader may complete a service transaction for the customer in the lobby. For example, the lobby leader may use a lobby leader terminal to perform the customer's transaction, e.g. a transfer of funds, thereby completing the customer's transaction in the lobby.

Additionally, the methods and features recited herein may further be implemented through any number of computer readable media that are able to store computer readable instructions. Examples of computer readable media that may be used include RAM, ROM, EEPROM, flash memory or other memory technology, CD-ROM, DVD, or other optical disk storage, magnetic cassettes, magnetic tape, magnetic storage and the like.

While illustrative systems and methods as described herein embodying various aspects are shown, it will be understood by those skilled in the art that the invention is not limited to these embodiments. Modifications may be made by those skilled in the art, particularly in light of the foregoing teachings. For example, each of the elements of the aforementioned embodiments may be utilized alone or in combination or subcombination with elements of the other embodiments. It will also be appreciated and understood that modifications may be made without departing from the true spirit and scope of the present invention. The description is thus to be regarded as illustrative instead of restrictive on the present invention.

I claim:

1. A system for customer management comprising:
a processor;
a memory, wherein the memory has stored thereon computer-readable instructions which, when executed by the processor, cause the system to perform steps comprising:
receiving customer identification information associated with a customer prior to customer interaction with a specialized customer service agent;
requesting additional customer information from a server;
receiving additional customer information from the server in response to the request;
identifying a transaction requested by the customer;
identifying a queue, from a plurality of queues, in which to place the customer based on at least one of: the requested transaction and the additional customer information; and
adding the customer to the identified queue.

2. The system of claim 1, wherein the additional customer information is bank account data.

3. The system of claim 1, wherein the customer identification information is received from a banking card.

4. The system of claim 1, wherein the customer identification information is received from a Radio Frequency Identification (RFID) device.

5. The system of claim 1, wherein the identified queue is ordered by customer priority status.

6. The system of claim 1, wherein the memory further comprises instructions for:
activating a chat functionality between the system and a second system of the specialized customer service agent.

7. The system of claim 1, wherein the system comprises a mobile computing device.

8. The system of claim 1, wherein the specialized customer service agent comprises a bank teller.

9. The system of claim 1, wherein the memory further comprises instructions for:
determining whether the received additional customer information includes a sales opportunity.

10. The system of claim 1, the memory further comprising instructions for: tracking one or more metrics associated with the requested transaction.

11. The system of claim 10, wherein tracking the one or more metrics comprises:
recording a duration for which a user is using the system in association with the requested transaction;

12. A method comprising:
receiving, at a lobby leader terminal, customer identification information associated with a customer prior to customer interaction with a specialized customer service agent;
requesting additional customer information from a server;
receiving additional customer information from the server in response to the request;
identifying a transaction requested by the customer;
identifying a queue, from a plurality of queues, in which to place the customer based on at least one of: the requested transaction and the additional customer information; and
adding the customer to the identified queue.

13. The method of claim 12, wherein the additional customer information is bank account data.

14. The method of claim 12, wherein the customer identification information is received from a banking card.

15. The method of claim 12, wherein the customer identification information is received from a Radio Frequency Identification (RFID) device.

16. The method of claim 12, wherein the identified queue is ordered by customer priority status.

17. The method of claim 12, further comprising:
activating a chat functionality between the lobby leader terminal and a second system.

18. A method for customer management comprising:
greeting a customer in a lobby of a business;
receiving customer identification information of the customer in the lobby;
determining a transaction requested by the customer;
queuing the customer based on at least one of: the customer's identification information and the requested transaction;
preparing the requested transaction; and
transferring the customer to an appropriate resource from the lobby.

19. The method of claim 18, wherein receiving customer identification information is performed through a wireless computing device.

20. The method of claim 19, wherein the customer identification information is received from at least one of: an radio frequency identification (RFID) device and an identification card.
